(19) United States
(12) Patent Application Publication
(10) Pub. No.: US 2026/0097378 A1
(43) Pub. Date: Apr. 9, 2026

(54) PROCESSES AND METHODS FOR PRODUCING HYDROGEN AND CARBON FROM HYDROCARBONS

(71) Applicant: C-ZERO, INC., Goleta, CA (US)

(72) Inventors: Eric MCFARLAND, Goleta, CA (US); Ye-Mon CHEN, Sugar Land, TX (US)

(21) Appl. No.: 19/102,233

(22) PCT Filed: Aug. 18, 2023
(86) PCT No.: PCT/US2023/030618

§ 371 Date: Feb. 7, 2025

Related U.S. Application Data
(60) Provisional application No. 63/399,057, filed on Aug. 18, 2022.

(51) Int. Cl. B01J 8/28; B01J 8/00; B01J 8/18; C01B 3/28; C01B 32/05

(52) U.S. Cl. CPC B01J 8/28; B01J 8/0055; B01J 8/1836; C01B 3/28; C01B 32/05; B01J 2208/00327; C01B 2203/0277; C01B 2203/1235

(57) ABSTRACT

A system includes a pyrolysis reactor containing a bed of particulates, a solids heating section, and a separator in fluid communication with the pyrolysis reactor through the product gas outlet. The pyrolysis reactor comprises a feed gas inlet at a lower portion of the bed, a product gas outlet above the bed, a particulate outlet above the feed gas inlet, a particulate inlet near the top of the bed, and a solids product outlet in a lower portion of the pyrolysis reactor. The solids heating section is configured to accept a portion of the particulates from the pyrolysis reactor through the particulate outlet, heat the portion of the particulates to form heated particulates, and return the heated particulates to the pyrolysis reactor through the particulate inlet, and the separator is configured to separate any particulates in a product gas produced, and return the particulates to the pyrolysis reactor.

### CROSS-REFERENCE TO RELATED APPLICATIONS

This application claims priority to U.S. Provisional Application No. 63/399,057 filed on Aug. 18, 2022 and entitled, “PROCESSES AND METHODS FOR PRODUCING HYDROGEN AND CARBON FROM HYDROCARBONS,” which is incorporated herein by reference in its entirety.

### BACKGROUND

In a variety of chemical processes, gas phase reactants can produce solid products that need to be removed from the reactor without the solid products adhering to internal structures within the reactor. The solid phase products can be desired products or side products. For example, the prevention of carbon deposition (coking) in the reaction of hydrocarbons is of major importance in many processes. It can also be difficult to add heat at high temperatures to many hydrocarbon reaction processes without depositing solid carbon on the heat transfer surfaces.

### SUMMARY

In some embodiments, a system for converting hydrocarbons gases to solid carbon and hydrogen products comprises a pyrolysis reactor containing a bed of particulates, a solids heating section in fluid communication with the particulate outlet and the particulate inlet, and a separator in fluid communication with the pyrolysis reactor through the product gas outlet. The pyrolysis reactor comprises a feed gas inlet at a lower portion of the bed, a product gas outlet above the bed, a particulate outlet above the feed gas inlet, a particulate inlet near the top of the bed, and a solids product outlet in a lower portion of the pyrolysis reactor. The solids heating section is configured to accept a portion of the particulates from the pyrolysis reactor through the particulate outlet, heat the portion of the particulates to form heated particulates, and return the heated particulates to the pyrolysis reactor through the particulate inlet, and the separator is configured to separate any particulates in a product gas produced in the pyrolysis reactor, and return the particulates to the pyrolysis reactor.

In some embodiments, a process for converting hydrocarbons gases to solid carbon and hydrogen products comprises contacting a hydrocarbon in a feed stream with a bed of particulates in a pyrolysis reactor, forming solid carbon on the particulates, forming gas phase products comprising hydrogen, removing a portion of the particulates with solid carbon products from the pyrolysis reactor, heating the portion of the particulates from the pyrolysis reactor to produce heated particulates in a solid heating section, and returning the heated particulates from a solid heating section to the pyrolysis reactor.

In some embodiments, a system for converting hydrocarbons gases to solid carbon and hydrogen products comprises a pyrolysis reactor containing a bed of particulates, and separator in fluid communication with the pyrolysis reactor through the product gas outlet in the upper portion of the pyrolysis reactor. The pyrolysis reactor comprises a feed gas inlet at a lower portion of the bed, a product gas outlet above the bed, a halogen inlet within the bed, and a solids product outlet of particulates with solid carbon in a lower portion of the pyrolysis reactor. The separator is configured to separate any particulates in a product gas produced from the pyrolysis reactor, and return the particulates to the pyrolysis reactor.

In some embodiments, a process for converting hydrocarbons gases to solid carbon and hydrogen products comprises introducing a feed stream comprising a hydrocarbon into a pyrolysis reactor, introducing an oxidant into the pyrolysis reactor, contacting a first portion of the hydrocarbon with a bed of particulates in the pyrolysis reactor, contacting a second portion of the hydrocarbon with the oxidant in the pyrolysis reactor, forming solid carbon on the particulates, forming gas phase products comprising hydrogen, reacting the second portion of the hydrocarbon with the oxidant to generate heat, and heating the bed of particulates to a pyrolysis reaction temperature using the heat.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description:

FIGS. 1A and 1B schematically illustrate a configuration of a tapered spouting bed reactor according to some embodiments.

FIG. 2 schematically illustrates a reactor system using a spouting bed reactor according to some embodiments.

FIGS. 3A and 3B illustrate exemplary cyclones that can be used within the embodiments disclosed herein.

FIG. 4 schematically illustrates another reactor system using a spouting bed reactor according to some embodiments.

FIGS. 5A and 5B schematically illustrate other reactor systems using a spouting bed reactor according to some embodiments.

FIGS. 6A and 6B schematically illustrates a non-mechanical valve useful in a reactor system according to some embodiments.

FIGS. 7A and 7B schematically illustrate other reactor systems using a spouting bed reactor according to some embodiments.

### DETAILED DESCRIPTION

In some aspects, hydrocarbon pyrolysis can be thought of as being a coker, with hydrogen as the by product, since methane pyrolysis produces 3 tons of coke for every ton of hydrogen. As used herein, coke refers to solid carbon, which can often be deposited on solid surfaces within a reaction system. Within a coker, carbon can grow on coke particles, e.g., in a fluid coker, but also in other refining and chemical processes. The general learning from these systems is that coke can attach to existing, hot solid surfaces, such as in a fluid coker where coke grows on top of existing, hot coke particles. In catalytic cracking, coke tends grows on the surfaces of regenerated, hot catalyst. As another example, an ethylene cracker has coke formation on the hot furnace tubes.

Various systems have made use of solid carbon beds for hydrocarbon pyrolysis. For example, some systems use a counter-current slow-moving bed of carbon to grow the solid carbon co-product on the downward moving carbon. Heat can be supplied to the solids in the reactor in the central zone. In one embodiment, electrical heating is employed. Other systems use a counter current reactor with circulating carbon in a series of cascade of fluid beds from high to low. Other systems use a process with dual fluidized beds, one as the pyrolysis reactor and the other as the carbon solids heater, whereby the carbon can be activated to serve as a catalyst and be heated prior to returning the solids to the methane pyrolysis reaction.

Disclosed herein is a hydrocarbon pyrolysis reactor system consisting of a pyrolysis reactor containing solid particles in fluid communication with a separate solid heating vessel, whereby using a number of different methods, solid particles can be heated to pyrolysis reaction temperature and returned to the pyrolysis reactor using a valving structure such as an obstruction-less valve (e.g., a non-mechanical valve) structure to maintain the pyrolysis reactor at reaction temperature. Hydrocarbon gases can be introduced into the pyrolysis reactor where they are decomposed into solid carbon and hydrogen. The solid carbon can deposit preferentially on the solid particles within the pyrolysis reactor and the gaseous hydrogen product can exit the reactor separate from the solid carbon.

In some embodiments, the pyrolysis reactor can be a spouting fluid bed where a temperature gradient is established within the reactor by introduction of low temperature hydrocarbon gas at the bottom of the reactor which maintains the lower region of the pyrolysis reactor at low temperature (e.g., relative to a reaction zone within the reactor) and particles heated in the heating section, which can comprise a riser reactor in which hot gases circulate and heat the solids withdrawn from the bottom of the reactor and return the heated solids to the top of the pyrolysis reactor which is maintained at a higher temperature than the bottom.

The current disclosed systems and methods apply to the production of solid carbon and hydrogen from various hydrocarbons and also uses various solid particles for carbon deposition, however, there are multiple key innovation components which have significant advantages over previous systems.

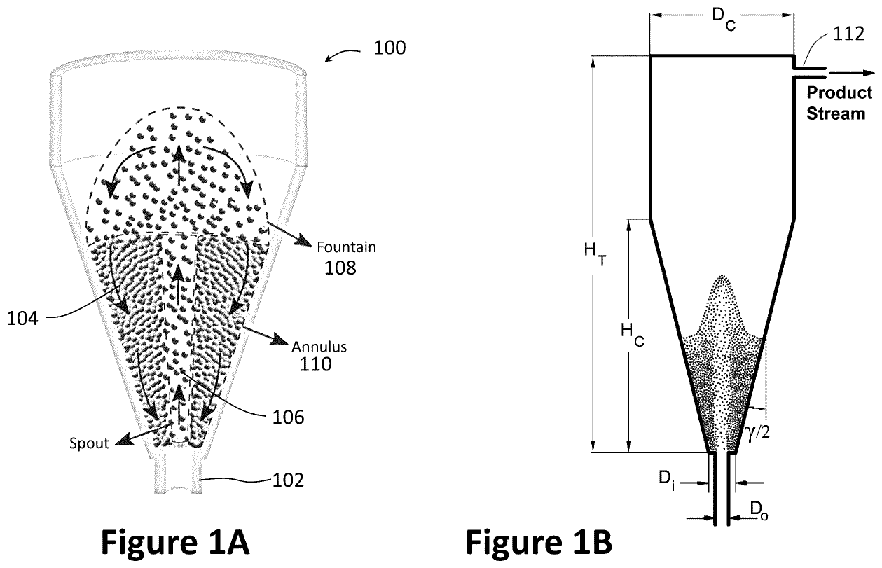

Firstly, some embodiments make use of a tapered spouting bed reactor (TSBR) 100. An embodiment of a TSBR is show in FIGS. 1A and 1B. As shown, gas can pass from an inlet 102 through a bed 104 filled with solid particulates to form a channel 106 through the entire solid bed 104. The gas inlet can be designed with a location and cross-sectional areas that is smaller than the lower portion of the reactor vessel such that the entering gas can form the channel 106 through the bed 104. The gas can entrain a portion of the particulates to form the channel 106 and a fountain 108 above the channel 106 that can return a portion of the particles to an annular region 110 filled with the particulates. The bed 104 can then circulate downwards where the particulates on the wall of the channel 106 can be entrained and carried to the fountain 108 portion. The product gases can leave through an outlet 112. This configuration can be referred to as a spouting bed in which specific particulate properties make the stable gas channel possible with a fraction of the solid moving upward with the gas, falling back to the bed surface, and circulating downward again. The nature of the circulation caused different size particles to stratify differently allowing a size range to be selectively removed. Further, the circulation can move high temperature solids counter-currently internally to contact relatively low temperature inlet gases and maintain a temperature gradient vertically. The operation of the spouting bed can be based on a specific gas velocity and flow rate to operate within a desired flow regime within the reactor, which can be controlled by the reaction system. In some aspects, the gas flowrate through the spouting bed can be maintained high enough to be above a bubbling, or turbulent flow regime through the particulate bed 104 and rather can maintain a stable channel 106.

As shown in FIG. 1B, the TSBR can have a lower inverted frusto-conical section holding the particulate bed 104. Above the surface of the particulate bed 104, the TSBR vessel can continue to expand to a final diameter D_{c} at a height H_{c}, and the resulting diameter can be maintained to a height H_{T}. The additional cylindrical section above the inverted frusto-conical section can serve to allow any entrained particulates to settle back to the particulate bed 104. Within this design, the high gas velocity can be maintained through the channel 106 to the upper surface of the particulate bed 104. The high gas velocity can entrain a portion of the particulates to form the fountain 108. The gas velocity above the upper surface of the particulate bed 104 can then slow as the cross-sectional flow area increases up to the top of the inverted conical section. This can allow any entrained particulates to settle out of the gas phase and return to the particulate bed, typically following the interior was of the inverted frusto-conical section to return to an outer portion of the particulate bed. The particulates can then circulate back through the bed to the channel wall.

In some aspects, any entrained particulates in the gas stream can be separated from the gas stream and returned to the bed 104. For example, one or more external cyclones may be utilized for returning particles to the solid bed, as described in more detail herein. In some aspects, an internal cyclone within the reactor can be used to separate at least a portion of the particulates to return the particulates to the bed. For example, the gas leaving the reactor vessel can pass through a cyclonic section to separate the particulates to an outer wall of the reactor vessel where the particulates can fall to a top of the bed.

When used for hydrocarbon pyrolysis, solid carbon can be produced from a hydrocarbon passing through the inlet 102 in the heated bed filled with solid particles (e.g., sand, solid carbon, catalyst, etc.), the reaction can occur predominately at the location with the highest temperature. In some aspects as described herein, this can be in the center channel nearest the inlet of the returned heated solids 234. Because there is some diffusion/percolation of the gases into the solid bed there will be additional carbon deposition on the particles forming the wall of the solids bed, causing growth of the bed and the particle sizes. When the bed is densely packed little bulk flow away from the central cavity occurs relative to the flow in the main channel.

The use of a TSBR 100 enables high hydrocarbon gas velocity and gas throughput without slugging or high entrainment of particulates into the separator. This design is in contrast to moving bed reactor designs that cannot operate at high gas velocity. A multi-tray fluidized bed also cannot operate with high gas velocity due to the tendency of such beds to flood at high velocities. Other designs with straight vertical walls are subject to slugging.

In the TSBR 100, the gas residence time can be relatively short, while the solid carbon product will have a longer residence time to allow carbon growth and elimination (decomposition) of the polyaromatic by-products. Within the spout or fountain of the TSBR, the entrained hot carbon particles above the spouting bed (e.g., in the fountain 108) can provide additional hydrocarbon conversion. The carbon can be preferentially deposited on the entrained hot carbon particles. This can help to reduce or eliminate coking on the vessel wall above the bed. Further, the particulates in the annular region 110 can help to insulate the walls of the reactor vessel, thereby allowing the walls to be constructed of lower cost materials.

As described in more detail herein, a portion of the particulates including some amount of solid carbon formed in the reaction can leaving with the gas stream. However, particulate entrainment from a tapered spouting bed into a downstream separation system such as a downstream cyclone system can be low, due to the expansion of the reactor in the dilute phase above the top of the bed that slows down the gas as it moves upward. Most entrained particles fall back onto the periphery around the spouting bed.

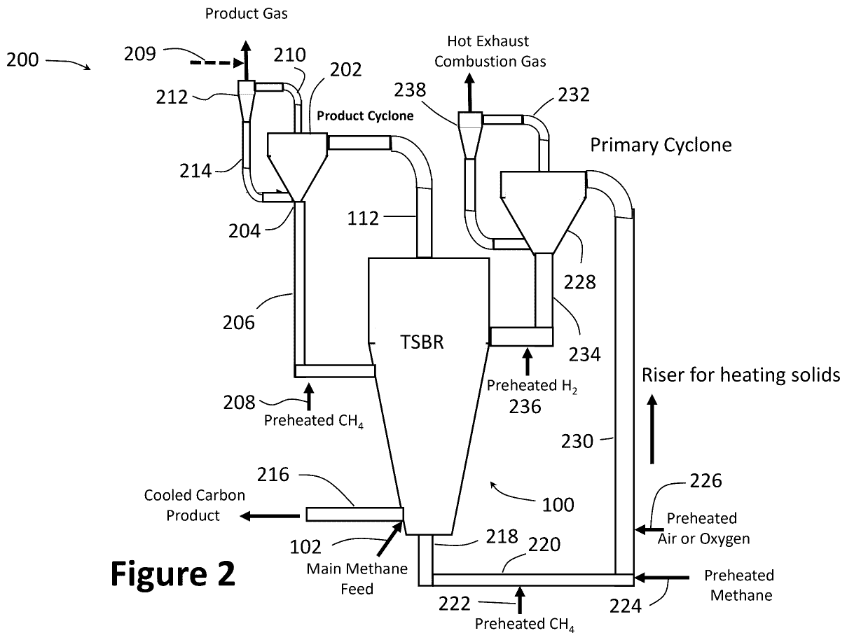

FIG. 2 illustrates an embodiment which incorporates a reaction system 200 comprising a TSBR 100 integrated with a heater section and external cyclones for separation of the solids and gases. As shown, a feed gas stream 102 can be introduced into the bottom of the TSBR 100. The TSBR 100 can be the same or similar to the TSBR 100 described with respect to FIGS. 1A and 1B. The feed gas can comprise any suitable hydrocarbon, including but not limited to, light alkanes such as methane, ethane, natural gas, alkenes, alcohols, as well as other gaseous hydrocarbons, including those that can be gasified such as the gasified or pyrolyzed products of liquid, and solid hydrocarbons (e.g. crude oil, biomass, naphtha, etc.).

As the gases react within the TSBR 100, hydrogen and solid carbon can be formed within the TSBR 100 with the solid carbon product formed preferentially on the solid particulates. The product gases can comprise hydrogen as well as some amount of unreacted hydrocarbons from the feed. The product gases can pass through the gas outlet 112 and pass to a separator such as a cyclone 202. The cyclone 202 and other cyclones within the system are described in more detail herein. Within the cyclone 202, the gas phase products can be separated from any entrained solids such as sold carbon and/or solid particulates using centrifugal force. The temperature within the cyclone 202 may be sufficiently high (e.g., above about 1100° C.) to further pyrolyze at least a portion of any remaining hydrocarbons in the gas phase and form carbon on the hot entrained particulates. In some aspect, the cyclone 202 can be operated as a high temperature external cyclones systems with cold wall design. The cyclone 202 may be operated a temperature suitable to convert any residual hydrocarbon, if any, in the gas or at a lower temperature to further cool down the product gas for heat recovery purpose. The solid separated from the gas stream can pass out of the solids outlet 204 to a charger 206 for the solids while the gas phase product can pass out of the upper outlet 210.

In some aspects, an additional stream 209 of cooled gas can be combined with the gas phase products to cool the product gases through direct contact. The cooler gas can be combined with the product gas stream downstream of any secondary cyclones such as cyclone 212. With the particulates removed, the product gas can be more readily cooled using a cooler gas stream. In some aspects, the cooler gas in stream 209 can be a cooled portion of the product gas. The product gas can be cooled to a desired level, which in some aspect may be sufficient to allow for further processing of the product gas stream.

The system 200 can comprise one or more optional secondary cyclones arranged in parallel and/or series to further remove entrained solids from the gas phase products. For example, a secondary cyclone 212 can be used to further remove any entrained solids from the gas phase exiting the cyclone 202. Any solids removed from the gas phase can be passed back to the outlet of the cyclone 202 and/or to the charger 206 to join with the solids from the cyclone 202. While only one secondary cyclone 212 is shown in FIG. 2, any number of further secondary cyclones can be used in series and/or parallel configurations to provide a product gas having a desired solids concentration. For example, from one to about 8 secondary cyclones may be coupled to the cyclone 202 to further separate any solids from the gas phase. The outlets of the second cyclones may join with the outlet of cyclone 202 upstream of the TSBR 100 to limit the number of connections and control components needed for the solids passing back to the TSBR 100.

In some aspects, the gas passing through the cyclone 202 may be cooled prior to passing out the system 200. In order to cool the product gas passing through the cyclone 202, the gas can be contacted with a cooler gas and/or a reaction can be used to cool the gas. In some aspects, a cooled gas can be combined with the product gas stream upstream of and/or within the cyclone 202. For example, a cooled hydrogen product stream can be recycled to the cyclone 202 to directly cool the product hydrogen stream. In some aspects, a reactant that can undergo an endothermic reaction with the product gas and/or within the cyclone 202 can be used to cool the product gas. For example, an alkene can be introduced into the cyclone (e.g., a first stage cyclone with a fluidize bed in the lower portion) to react with the solids of the fluidized bed in the lower portion of the cyclone in an endothermic reaction. The endothermic reaction can then cool the product gas passing through the cyclone 202. Any other suitable methods of cooling the product gas can also be used.

The solids removed from the product gas can collect and pass back to the TSBR 100 through the charger 206. Various designs can be used to control the feed rate of the solids back into the TSBR 100. Further, heat integration can be used to pre-heat the solids in the charger 206 prior to passing the solids into the high temperature region at the top of the TSBR 100 bed. For example, a pre-heated hydrocarbon stream 208 can be introduced into the charger 206 to pass back into the TSBR 100 with the solids into the high temperature top spout zone of the TSBR.

The solid carbon product from the TSBR 100 can circulate and pass to an outlet 216. The solid carbon outlet 216 can be positioned in a lower portion of the particulate bed where a lower temperature can be maintained by the introduction of relatively low temperature feed gas counter current to cool the solid carbon product, as described in more detail herein. In some aspects, the solid carbon product can pass through the outlet 216 at a temperature in a range of about 900° C. to about 1200° C., or between about 950° C. to about 1100° C. Various techniques including pneumatic conveyance can be used to remove the relatively cool solid carbon from the TSBR 100 to the solid carbon product vessel via pressure differential between the two vessels. The solid carbon can be further processed or otherwise removed from the system. As noted herein, in some aspects, the solid carbon can form on the particulates within the bed. When the particulates are solid carbon particles, the solid product can comprise pure or nearly pure carbon. When another type of particulate is used such as sand or catalyst particles, the solid product can comprise the solid carbon and some amount of particulate matter, which can be removed or/and handled with the solid carbon product.

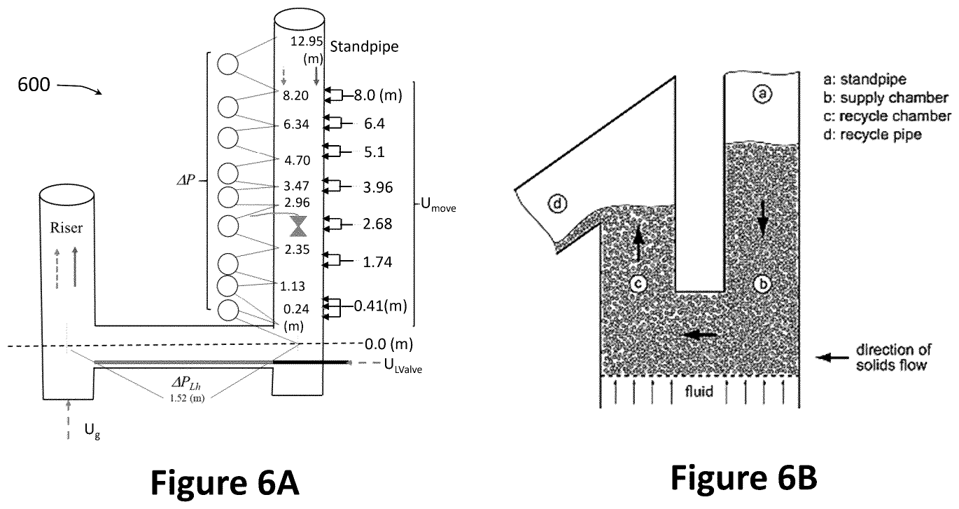

The system 200 further comprises a heater section configured to heat the particulates removed from the particulate bed in the TSBR 100, thereby allowing for the heated particulates to be returned to the top of the bed in the TSBR 100 to provide the heat for the reaction. As shown in FIG. 2, the particulates can pass through a particulate outlet 218 into a transfer section 220 before passing to a riser 230 for heating. In some aspects, the riser 230 can be in fluid communication with the TSBR 100 through the particulate outlet 218 by way of a non-mechanical valve such as an L-valve or loop seal (e.g., as described with respect to FIGS. 6A and 6B), which can use a gas to convey the solids in the direction of a pressure drop. As described in more detail herein, this configuration can allow the particulates to be conveyed from the TSBR 100 along the transfer section 220 into the riser section 230. In some aspects, the gas used for the transfer of the particulates can comprise a hydrocarbon stream 222 such as a preheated methane stream. While shown as methane, other hydrocarbons, including any of those used for the feed gas, can also be used as the transfer gas.

The riser 230 can allow the solids to be heated to very high temperatures using combustion or a pre-heated gas (e.g., an electrically heated gases, etc.) in direct contact with the solids. As an alternative a loop seal or an L-valve may also be used as a non-mechanical valve. Use of the riser section 230 in this specific configuration can enable a low-cost means of providing the heat of reaction in a stream of heated solid particles returned to the top of the TSBR 100 using direct combustion of hydrocarbons or hydrogen in an oxygen containing gas such as air or oxygen, or by electrically heating an injected gas stream (e.g. hydrogen, an inert gas, etc.). Further, using a non-mechanical valve for both controlling cool carbon particles fed to the riser and isolation of oxygen/air coming from riser. The riser provides the mean of a short reaction time for hydrocarbon combustion, reducing or minimizing solid carbon combustion.

In some aspects, the heating within the riser section 230 can be accomplished by the combustion of a gas within the riser section to directly heat the particulates within the riser section 230. As shown in FIG. 2, one or more streams of a combustion hydrocarbon gas 222, 224 (e.g., a hydrocarbon, hydrogen, etc.) can be used to convey the particulates within the riser section 230. Within the riser section 230, a source of oxygen can be introduced in stream 226. The oxygen source can comprise air and/or an oxygen enriched stream. An oxygen enriched stream refers to any stream having an oxygen concentration greater than the atmospheric concentration of oxygen. The oxygen stream can be obtained at a desired purity from an oxygen storage tank, or via an oxygen enrichment process, for example, the separation of air into nitrogen and oxygen, such as pressure swing adsorption (PSA), vacuum swing adsorption (VSA), or cryogenic separation techniques. The oxygen in the oxygen stream may have at least about 70 vol %, at least 80 vol %, or at least 90 vol % oxygen (e.g., 90, 91, 92, 93, 94, 95, 96, 97, 98, 99, 99.1, 99.2, 99.3, 99.4, 99.5, 99.6, 99.7, 99.8, 99.9, or 100 vol % oxygen). In some aspects, hydrogen can be used as the combustion gas in place of the hydrocarbon in the riser section 230. This may allow for the combustion products to comprise steam rather than a carbon oxide such as carbon dioxide. While shown as a single stream entering the lower portion of the riser section 230, the air and/or oxygen enriched stream 226 may be introduced as two or more separate streams along the length of the riser section 230. The use of the riser provides flexibility in the means of combustion heating of carbon in the riser. In some embodiments, air or oxygen enriched in a gas streams are used for combustion to reach high temperatures more efficiently in the riser and produce either a more purified carbon dioxide stream readily sequestered if hydrocarbon combustion is used, or steam if hydrogen combustion is utilized. The use of the riser also provides the elevation and high pressure differential for returning the heated particulates to the upper portion of the pyrolysis reactor.

The hydrocarbon and oxygen can combust within the riser section 230 to form a combustion product gas and heat. The combustion product gas products can include gas phase products such as carbon monoxide, carbon dioxide, water, and unreacted hydrocarbons. When oxygen enriched gas is used, the amount of nitrogen present may be decreased and the concentration of carbon monoxide, carbon dioxide and water may be increased. This may allow for a more concentrated carbon dioxide stream leaving the system if separation of the carbon dioxide is desired. The particulates can be heated to a temperature between about 700° C. and about 1400° C. in the riser section.

The product stream from the riser section 230 can pass to a primary cyclone separator 228 to separate the hot particulates from the gas phase products. The heated particulates can pass through the solids outlet 234 to a location near (e.g., at or above) the top of the particulate bed in the TSBR 100. A preheated hydrogen stream 236 can be passed through the particulates in the solids outlet 234 to prevent any backflow of oxygen containing gases into the TSBR 100 and convey the solids in the L-valve. The hydrogen in hydrogen stream 236 can provide a reducing environment to react any remaining oxygen and prevent the oxygen from entering the TSBR 100. The heated particulates can then pass into an upper portion of the TSBR 100 through the non-mechanical valve to carry out the reactions. As shown in FIG. 2, the riser section 230 can then serve to lift and heat the particulates to allow the particulates to flow by gravity and/or pneumatic conveyance back to the TSBR 100 through the non-mechanical valve. For example, the riser can lift the hot particulates to a high elevation and provide the means of a robust pressure differential for circulating hot particulates to the top of the TSBR 100.

The gas phase products and/or other gases associated with heating the solids in the riser can pass out of the cyclone 228 for further processing and/or heat recovery through the gas outlet 232. The system 200 can comprise one or more optional secondary cyclones to further remove entrained solids from the gas phase products from the riser section. For example, one or more secondary cyclones 238 can be used to further remove any entrained solids from the gas phase exiting the cyclone 228. Any solids removed from the gas phase can be passed back to the outlet of the cyclone to join with the solids in the solids outlet 234 from the cyclone 228. While only one secondary cyclone 238 is shown in FIG. 2, any number of further secondary cyclones can be used in series and/or parallel configurations to provide a product gas having a desired solids concentration. For example, from one to about 8 secondary cyclones may be coupled to the cyclone 228 to further separate any solids from the gas phase. The outlets of the second cyclones may join with the outlet of cyclone 228 upstream of the TSBR 100 to limit the number of connections and control components needed for the solids passing back to the TSBR 100.

The use of the cyclones and secondary cyclones provide a number of advantages. The present system makes use of one or more external cyclones for riser termination and hot carbon particles separation and return as well as external secondary cyclones. The primary cyclones provide a means to capture most of the heated solid particulates and return the particulates to the reactor for heat addition. The primary cyclones can terminate with a non-mechanical valve for both the control of carbon particle circulation and isolation of oxygen from the hydrocarbons in the reactor. The use of the riser and the cyclone system can also be used for starting up the reactor system by heating and circulating a solid media, methane and air/oxygen. For example, the riser section can be operated to heat the particulates within the TSBR 100 prior to or during the introduction of hydrocarbons to the TSBR 100.

The external cyclone system can enable a cold wall design of the entire heating system allowing for very high temperature operation with only stable refractory materials in contact with reaction participants and heating gases. For example, the various elements of the system 200, including those within the heat supply system (e.g., the riser section 230, cyclone 228, and transfer conduits, etc.) can be of a cold wall design. Cold wall design generally refers to an internally refractor lines vessels where the external walls are not insulated. This design may help to avoid the use of expensive materials while also limiting the potential for the deposition of carbon on the walls of the reactors, cyclones, and conduits themselves. Rather, the carbon may preferentially deposit on the hot particulates and avoid the buildup of coke on the internal process surfaces.

The reactor system uses the circulation of a high temperature solid media on which hydrocarbon pyrolysis occurs. Any suitable solids can be used within the system such as solid carbon, sand, catalytic particles, and the like. Catalytic particles can include particles containing catalytic components such as iron (e.g., iron oxide), nickel, cobalt, or any other suitably catalytic components. In some aspects, the solid can be carbon. In some aspects, the solid can be sand or other stable chemically inert ceramics. In the case of sands consisting of primarily silica, the formation of dense carbon solids rather than low density soot like carbon may be possible on the sand. The high-density carbon has improved handling advantages. Further, the materials have high melting temperatures in excess of the required pyrolysis temperatures. Sands is also low cost and there is long industrial experience using particulates comprising sand in fluidized bed reactors.

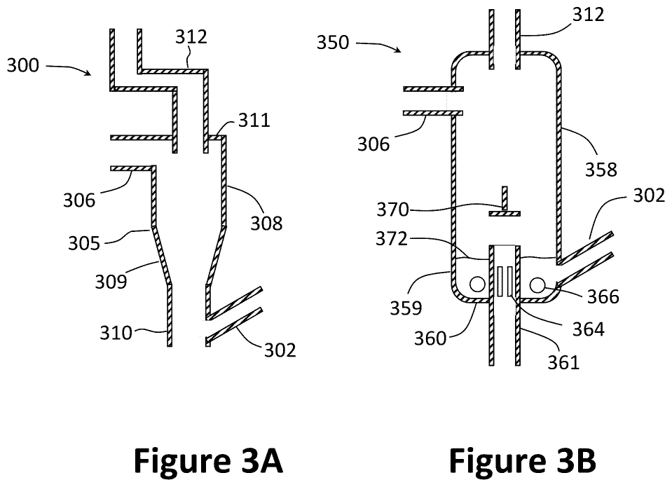

The cyclones used within the system can comprise any suitable cyclones. Examples can include a traditional cyclone separator, a stripper cyclone, or any other cyclone designs that are suitable for separating a gas phase from a solid phase. FIG. 3A illustrates an embodiment of a cyclone design. As shown in FIG. 3A, the cyclone 300 can comprise a vertical cyclone separator 305. The cyclone separator 305 can have an inlet 306 for receiving gas and solid particulates, for example from the riser of the heater section and/or the gas phase outlet of the TSBR 100. The cyclone further comprises an upper tubular 308, a conical portion 309 and a dipleg 310. The cyclone housing 305 can further comprise an upper roof or shoulder 311 through which a gas outlet 312 can pass to provide an outlet for the gas phase. The inlet 306 can be arranged to enter the cyclone housing 305 tangentially to the wall to create a circulation or vortex within the cyclone housing 305. The resulting vortex can force the particulates to the outer wall to fall downwards to the dipleg 310 to pass out of the cyclone housing 305. The central gas region of the vortex can then allow the gas phase to pass upwards through the gas outlet 312. The combination of the shoulder 311 and the extension of the outlet 312 into the cyclone 305 can help to reduce or prevent any solid particulates from passing out the cyclone with the gas phase. One or more solids passages 302 can be used to return the solids from any secondary cyclones to the dipleg 310 of the cyclone housing 305. While shown as being at or within the dipleg 310, the one or more solids passages 302 can join in with the solids conduit at any point between the cyclone and the TSBR 100. Any of the secondary cyclones as described herein can have a design that is the same as or similar to the design of the cyclone housing 305 wherein the inlet to such secondary cyclones would be fluidly coupled to the outlet 312 of the cyclone housing 305, and the solids outlet from such secondary cyclones would be fluidly coupled to a solids passage 302 to return the solids to the TSBR 100.

In some embodiments, any of the cyclones described herein (e.g., cyclone 202, cyclone 228, and/or any secondary cyclones) can comprise a stripper cyclone. In general, a stripper cyclone can comprise a cyclone comprising a solid inventory within the cyclone with a stripping gas being introduced and passed through the solids within the cyclone to maintain the solids as a fluidized bed. In some aspects, the use of a stripper cyclone with sufficient solid inventory (e.g., operating as a small fluidized bed) may allow for stable control of carbon particle circulation. In this embodiment, the particulates captured in the secondary cyclones can be maintained as a supply of particulates that can be controllably sent back to the primary cyclones. This may aid in maintaining a desired particulate level within the TSBR 100 and can allow for startup operations. The use of a stripper cyclone also serves as receiving vessel for the return from secondary cyclone(s), making the cyclone system simple and compact. The use of a secondary or stripper cyclone can also serve as a receiving vessel for the potential use of sand for initiating the carbon particles and for energy integration.

FIG. 3B schematically illustrates an embodiment of a stripper cyclone 350. The stripper cyclone 350 is similar to the cyclone 300 of FIG. 3A, except that the cyclone 350 comprises a lower portion 359 of the cyclone housing 358 having a closed lower end 360. A particulate outlet 361 extends through the closed lower end 360 and into the cyclone 350. The particulate outlet 361 can comprise a tubular structure having an open upper end within the cyclone 350 that is below the inlet 306. The particulate outlet 361 has a diameter that is less than an inner wall of the cyclone 350 so that an annulus is formed between an outer wall of the particulate outlet 361 and an inner wall of the cyclone 350 within the cyclone 350. The particulate outlet 361 also comprises one or more openings 364 that can be in the form of vertical or horizontal slots, round or oval openings, or any other suitable shape. The openings 364 can be located between the top of the particulate outlet 361 and the closed lower end 360 of the cyclone 350.

A vortex finder 370 can be located above the top of the particulate outlet 361. The vortex finder can comprise a horizontal vortex stabilizer plate or cone and a stabilizer rod to hold the vortex stabilizer plate in position. The vortex finder 370 serves to reduce the gas velocity below the vortex finder 370 so that the main separation of the solids from the gas phase occurs above the vortex finder 370.

A stripping section can be formed in a lower portion of the cyclone 350 below the vortex finder 370. Based on the design of the particulate outlet 361, a solid inventory can be maintained within the cyclone 350 where the upper surface 372 of the solids bed can generally be maintained below the upper end of the particulate outlet 361. In order to provide a stripping gas that can also be used to keep the particulate bed fluidized, one or more gas inlets 366 can be arranged as a gas ring at or near the bottom of the cyclone 350. The gas introduced into the gas inlets 366 can pass through the particulate bed and pass upwards to enter the gas phase and pass out of the cyclone 350 with the gas phase entering the cyclone 350 through the inlet 306. The gas flow can be controlled to maintain the particulate bed in a fluidized state.

One or more solids passages 302 can be in fluid communication with one or more secondary cyclones as described herein. The solids passages 302 can allow the solids separated from the gas leaving the cyclone 350 to pass into the particulate bed within the cyclone 350, where the solids can be further stripped and maintained as a solids inventory prior to passing back to the TSBR 100.

In use, the gas and solids passing into the cyclone 350 can enter the upper portion of the cyclone 350 with the gas inlet 306 being arranged tangentially to the inner wall of the cyclone 350. As the gas phase and solids form a vortex, the solids phase can pass to an outer wall and fall into the particulate bed in the lower portion of the cyclone 350 while the gas phase can leave through the outlet 312. The vortex finder 370 can maintain the vortex above the vortex finder 370 and reduce the gas velocity in the lower portion of the cyclone 350 below the vortex finder 370. The particulates falling from the upper section can then form a particulate bed in a lower portion of the cyclone 350.

The stripping gas can be introduced through the gas inlets 366 to fluidize the particulate bed. The fluidized particulates can then pass through the openings 364 and pass through the particulate outlet. A level controller can be used to control the fluidizing gas flow to maintain the level of the particulate bed within the cyclone 350.

In some aspects, the stripping gas introduced through the gas inlets 366 can comprise an oxidizing gas such as air or oxygen. The gas entering the cyclone 350 may comprise some amount of carbon monoxide based on the oxygen to hydrocarbon ratio introduced in the heater section. The oxygen introduced through the stripping gas can then be controlled to adjust the level of carbon monoxide within the gas exiting the cyclone through the outlet 312. The resulting combustion of any remaining hydrocarbons and/or carbon monoxide can further heat the particulates in the particulate bed, though the main heat may be produced in the heater section.

As further noted, the ability to control the particulate bed level in the stripper cyclone 350 can have a further advantage of maintaining an inventory of particulates for use with the TSBR 100. In addition, the use of a stripper cyclone can allow the particulates to be collected from one or more secondary cyclones and passed to the TSBR 100 from a single location. Thus, in some embodiments, one or more of the cyclones within the systems described herein may be stripper cyclones. When used with the product cyclone 202, the use of the stripper cyclone may also allow for heat integration and/or control of the temperature of the carbon based on use of stripping gas.

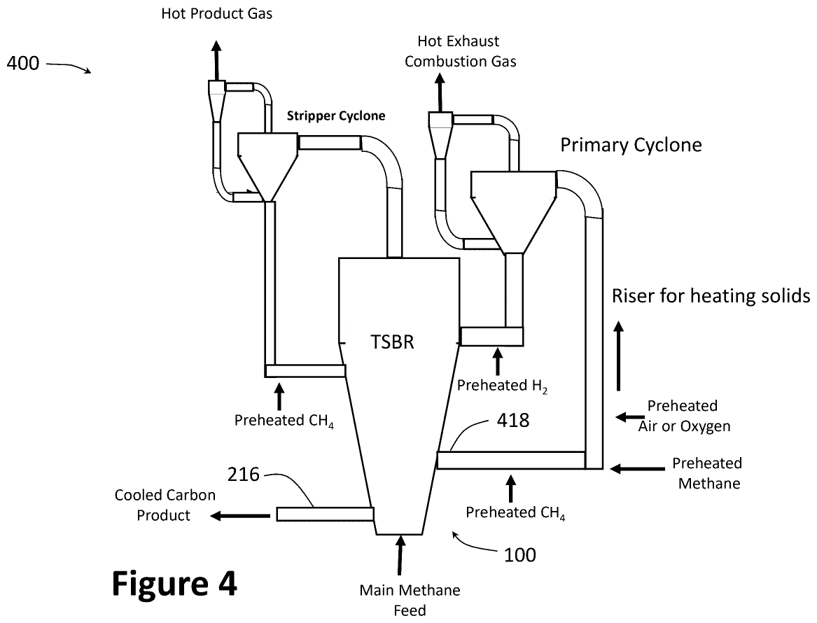

FIG. 4 illustrates another embodiment that is similar or the same as the embodiment of FIG. 2. In the interest of brevity, like components will not be re-described in detail. The main difference between the system 200 of FIG. 2 and the system 400 of FIG. 4 is the location of the particulate outlet 418 from the TSBR 100. As shown in FIG. 4, the particulate outlet passing into the transfer conduit 418 may be positioned above the carbon product outlet 216. By altering the level where particulates are removed for heating, the heat profile within the TSBR 100 can be controlled. For example, when the particulate outlet is above the carbon product outlet 216, the lower sections of the reactor can be maintained at lower temperatures and the carbon product exiting the reactor can be cooler. In some embodiments, the temperature at or near the top of the particulate bed in the TSBR 100 may be at a temperature between about 1,400° C. and about 1,200, and the temperature at or near the bottom of the particulate bed (e.g., at or near the carbon product outlet 216) may be at a temperature between about 800° C. and about 1100° C., or between about 950° C. and about 1050° C.

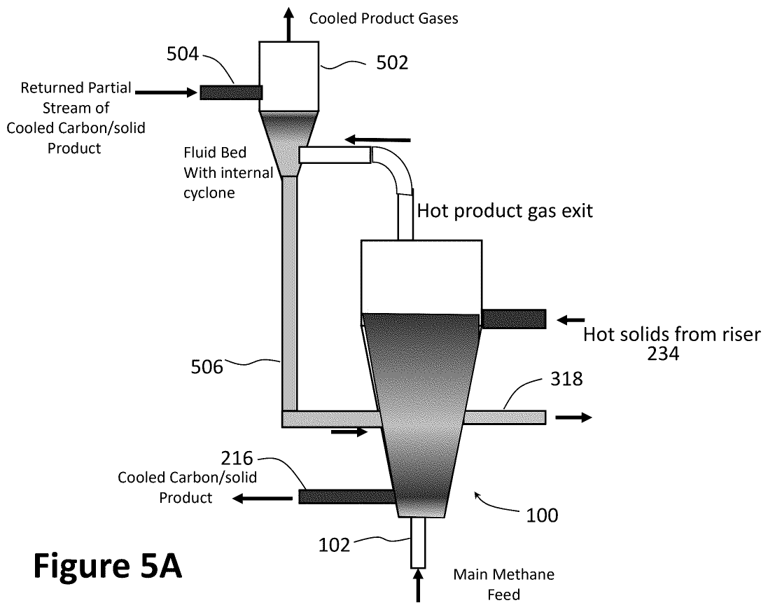

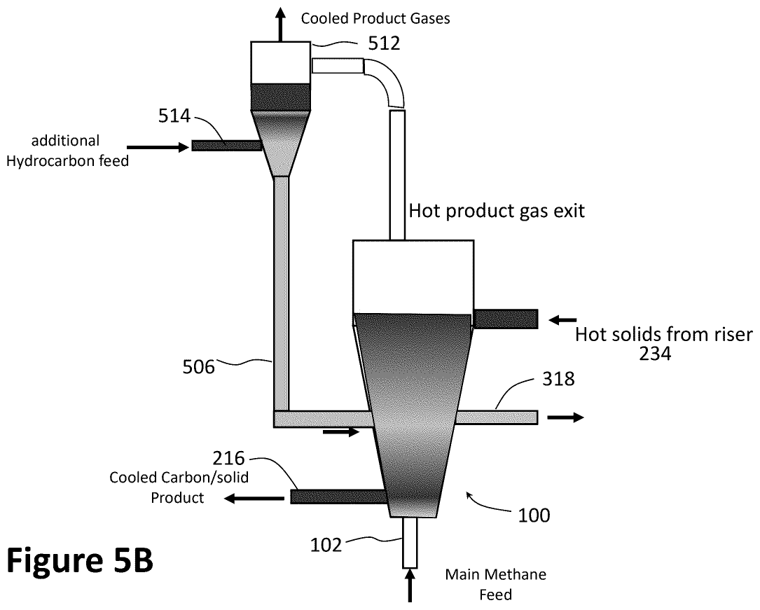

In some embodiments, a heat profile is shown schematically in FIG. 5A. The embodiment of FIG. 5A can comprise a portion of the system 200 described with respect to FIG. 2 and/or the system 400 described with respect to FIG. 4. In some embodiments, selective introduction of the particulates such as solid carbon into the TSBR 100 allows for efficient heat integration. A unique feature of the disclosed systems is the creation of the temperature gradient within the TSBR with the highest temperature at the top of the bed in the spouting region allowing reaction to deposit carbon on the spouted solids. Reference is made to FIG. 5A with colors qualitatively correlating to temperatures (with cooler temperatures at the bottom and hotter temperatures at the top of the particulate bed). The primary feed of relatively cool hydrocarbon gas can be introduced at the bottom of the TSBR 100 which transfers heat from the surrounding solids to heat the hydrocarbon gas to reaction temperatures as the gases rise while cooling the solid carbon moving downward in the reactor to a non-mechanical valve near the bottom, where the solids can be removed as a relatively cool solid stream.

As shown, use of a TSBR 100 with high temperature heated particulates (e.g., carbon, sand, etc.) introduced continuously at the top of the bed through stream 234 and low temperature hydrocarbon introduced continuously at the bottom of the bed through stream 102 allows for the maintenance of a steady-state temperature gradient from the cooling of the bed bottom by heating of the relatively colder hydrocarbon feed. For example, the temperature of the hydrocarbon feed can be controlled to produce a carbon product having a desired outlet temperature while the rate and temperature of the particulates introduced at the top through stream 234 and the intermediate location through stream 506 can be controlled to produce the desired temperature profile within the TSBR 100.

The configurations shown herein allow for a number of heat integration configurations to retain heat within the system. During operation, the carbon product stream 216 can be removed continuously from the bottom of the bed after being cooled by the incoming hydrocarbon feed passing to the reaction zone. Recovering the heat from the cooling solids using the preheated feed provides heat integration for hydrocarbon pyrolysis. Hot carbon fed at the top of the bed within the TSBR 100 creates a desirable steady-state adiabatic temperature profile with the highest reactor temperature at the top of the bed, which drives highest hydrocarbon conversion at the reactor gas exit from the bed (e.g., in the fountain portion). The bottom of the bed where the hydrocarbon is introduced is cooled as the entering gas is heated. The cooler carbon is removed as the co-product at the bottom.

Within this system, the cyclone used to separate the gas phase products from the TSBR 100 can be operated as a separator 502 having a fluidized bed with an internal cyclone. In this embodiment, the separator 502 can store a portion of the solids separated from the gas phase products within the separator 502. The gas phase products from the TSBR 100 can pass into a lower portion of the separator 502 within the bed of particulates. The hot gas phase products can then exchange heat with the particulates in the fluidized bed within the separator 502. Additional reaction (e.g., pyrolysis) of hydrocarbons in the fluidized bed can cool the particulates and gas. In addition, a stream 504 of the carbon product that is cooled can be returned to the fluidized bed separator 502 to cool the gas phase products while pre-heating the particulates for use in the TSBR 100. For example, a portion of the cooled solid product stream 216 can be returned to the separator 502 as stream 504. The cooled solids can cool the hot gasses passing through the fluidized bed within the separator 502 so that the product gases leaving the separator 502 can be cooled and leave the system. In some aspects, an internal cyclone can be used within the separator 502 to separate the particulates in the fluidized bed from the gas stream, thereby helping to retain the particulates within the separator 502. The partially heated solids can be returned to the TSRB 100 either above or below the hot solids return stream. The position of the introduction of stream 506 can be selected to match or provide a desired temperature profile within the TSBR 100 bed. In some aspects, one or more primary and/or secondary cyclones can be coupled to the outlet of the separator 502 as described herein to remove any remaining particulates entrained in the cooled product gases. The solids to be heated in the riser to provide the reaction heat can be withdrawn through outlet 318 part way down the bed and sent to the riser section where they can be heated.

FIG. 5B illustrates another embodiment that is similar to the embodiment of FIG. 5A, and similar elements will not be re-described in the interest of brevity. The embodiment of FIG. 5B can comprise a portion of the system 200 described with respect to FIG. 2 and/or the system 400 described with respect to FIG. 4. Within this system, the cyclone separator 512 used to separate the gas phase products from any entrained particulates can be operated as a cyclone (e.g., a stripper cyclone) as described herein. In this embodiment, the cyclone separator 512 can store a portion of the solids separated from the gas phase products within the cyclone separator 512. A stream of gas 514 can be returned to the cyclone to serve as the fluidization gas for the particulates in the lower portion of the cyclone separator 512. The fluidization gas can comprise a cooled gas to cool the particulates. In some aspects, the gas can comprise a hydrocarbon (e.g., any of those described herein) where the resulting pyrolysis reaction of the hydrocarbons with the particulates can serve to cool the particulates and the product gases passing through the cyclone 512. When additional cooling is desired, the product gas can be quenched using a cooled gas stream combined with the product gas stream that can be combined downstream of the cyclone separator 512 and/or any secondary cyclones coupled to the cyclone separator 512. The product gases can leave the system, while the partially heated solids can be returned to the TSRB 100 either above or below the hot solids return stream. The position of the introduction of stream 506 can be selected to match or provide a desired temperature profile within the TSBR 100 bed. The solids to be heated in the riser to provide the reaction heat can be withdrawn through outlet 318 part way down the bed and sent to the riser section where they can be heated.

In any of the embodiments disclosed herein, one or more non-mechanical valves can be used to control the flow of solids and/or gases within the system. For example, the solids passing out of the TSBR 100 to the heater section, the solids passing out of the heater section cyclone, and/or the solids passing out of the product gas cyclone can each pass through and be controlled by a non-mechanical valve in some embodiments. Due to the high temperatures present within the systems, mechanical valves may not be capable of operating or may have operational issues over time. In some aspects, the non-mechanical valve can enable movement of the solid particulates while providing isolation of the gases. For example, use of a non-mechanical valve for isolation of gases on each side of the reactor system one side with combustion and one side with reduction/dehydrogenation allows both isolation and the control of particle circulation rate and bed levels. The non-mechanical valve also provides a workable method for circulating the particles while isolating the gases on each side of the reactor where mechanical valves (e.g. slide valves) may not survive the high temp.

FIGS. 6A and 6B illustrate two common non-mechanical valves. FIG. 6A illustrates an L-valve 600 and FIG. 6B a loop-seal. Such conduits are used in circulating fluidized bed systems to convey particles from a low-pressure region to a high-pressure region and avoid inverse gas flow and provide for effective gas tightness. Such valves can be used for controlling the movement of solids such as withdrawing cold and large carbon particles at the bottom of the TSBR 100. As illustrated in FIG. 6A, the riser section is shown on the left-hand side, and the particulate outlet or standpipe is illustrated on the right-hand side. The valve relies on a pressure differential created by the presence of the particles present within the standpipe relative to the shorter particle height on the outlet to create a gas phase flow that can carry the particulates. As shown in FIG. 5B, the particulates can accumulate in the loop-seal standpipe, and when gas is introduced on the left-hand side, the particles can be lifted to the recycle or outlet pipe. The recycle or outlet pipe can be the riser section in some aspects and/or any of the other transfer lines (e.g., the solid carbon outlet from the TSBR, the solids outlet from the cyclones, etc.) described herein. As the solid carbon moves to the outlet pipe, the solids in the standpipe can move towards the outlet. Further, the gas phase used to move the particulates will preferentially flow towards the outlet due to the pressure differential created by the presence of the particulates in the standpipe. Thus, the design can be used as a valve without any mechanically moving elements.

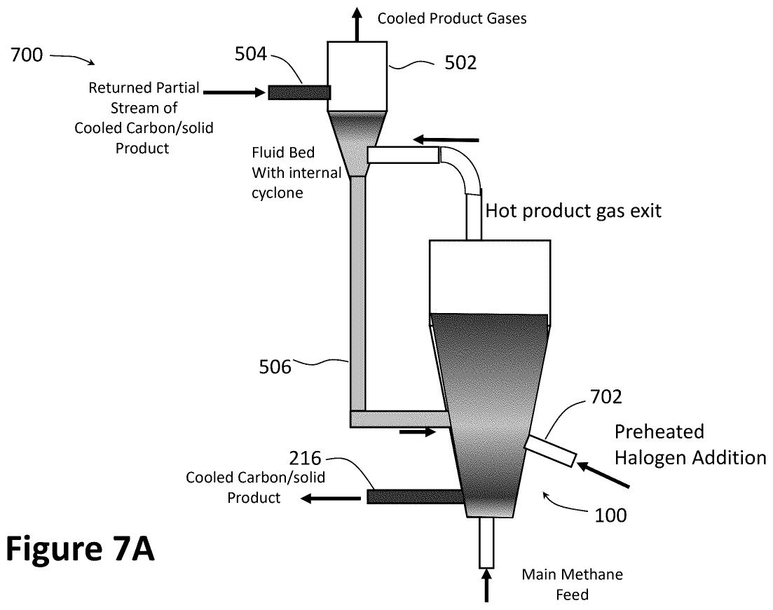

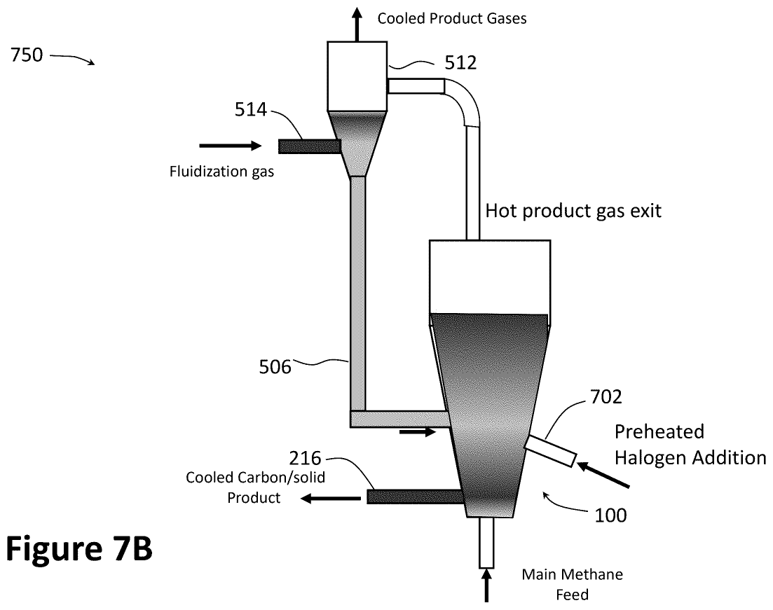

FIG. 7A illustrates another embodiment of a reactor system 700 that can rely on a reaction within the TSBR 100 to provide the heat required to decompose the hydrocarbon. This configuration may advantageously eliminate the need for the riser section to simplify the overall process. As shown, an oxidant can be introduced as stream 702 into a lower portion of the particulate bed, where the oxidant can be reacted with a portion of the hydrocarbon in the TSBR 100 in sufficient quantity to generate heat so that no heat is required to be added for the decomposition reaction (e.g., autothermal or exothermic). Any suitable oxidant can be used such as a halogen (e.g., chlorine, bromine, etc.), an oxygen containing gas (e.g., oxygen, etc.), sulfur, or the like. The shades shown qualitatively correlating to temperatures, with lower temperatures at the bottom of the TSBR 100 and higher temperatures at or near the surface of the particulate bed. The primary feed of relatively cool hydrocarbon gas can be introduced at the bottom of the TSBR 100, which transfers heat from the surrounding solids to heat the hydrocarbon gas to reaction temperatures as the reaction gases rise while cooling the solid carbon moving downward in the reactor to a non-mechanical valve near the bottom, where the solid carbon product is removed as a relatively cool solid stream 216. A portion of the cooled solid can be optionally returned to the exit gas separator as stream 504, which in this instance can be a separator containing a fluidized bed as described herein with respect to FIG. 5A, whereby hot product gases leaving the TSBR 100 can be introduced into the cyclone 502, where the gas phase can be cooled and exit while the partially heated solids can be returned to the TSRB 100 as stream 506, as described in more detail herein.

FIG. 7B illustrates another embodiment of a reactor system 750 that can rely on a reaction within the TSBR 100 to provide the heat required to decompose the hydrocarbon. The embodiment of FIG. 7B is similar to the embodiment of FIG. 7A, except that the outlet gas separator can comprise a stripper cyclone 512. The stripper cyclone can be the same as and operate in the same or a similar manner to the cyclone 512 described with respect to FIG. 5B. As shown, the product gasses can pass to the cyclone 512 with the bed or particulates in the lower portion of the cyclone 512 receiving a fluidization gas in stream 514 that can comprise a hydrocarbon gas to cool the particulates through a pyrolysis reaction. The solids can then be returned to the TSRB 100 as stream 506, as described in more detail herein.

When a halogen is used as the oxidant, the halogen can be recovered downstream to generate hydrogen and the elemental halogen, thereby allowing the halogen to be recycled within the system. When oxygen is used, carbon monoxide and/or carbon dioxide may be produced. In some aspects, the amount of carbon dioxide produced may be low enough to remain in the produced hydrogen stream, or the carbon monoxide and/or carbon dioxide, or any portion thereof, can be removed downstream of the TSBR 100. The main advantage of using the oxidant can include the ability to heat the particulate bed within the TSBR 100 itself rather than relying on external heating of the particulates. This may allow the reaction temperature within the TSBR 100 to be at or below about 1100° C. and reduce or eliminate the need to provide other forms of external heat into the TSBR 100. This configuration can also allow the reactor to be started up and brought to steady-state by addition of excess oxidant.

Having described various systems, reactors, and methods, certain aspects can include, but are not limited to:

In a first aspect, a system for converting hydrocarbons gases to solid carbon and hydrogen products, the system comprises: a pyrolysis reactor containing a bed of particulates, wherein the pyrolysis reactor comprises a feed gas inlet at a lower portion of the bed, a product gas outlet above the bed, a particulate outlet above the feed gas inlet, a particulate inlet near the top of the bed, and a solids product outlet in a lower portion of the pyrolysis reactor; a solids heating section in fluid communication with the particulate outlet and the particulate inlet, wherein the solids heating section is configured to accept a portion of the particulates from the pyrolysis reactor through the particulate outlet, heat the portion of the particulates to form heated particulates, and return the heated particulates to the pyrolysis reactor through the particulate inlet; and a separator in fluid communication with the pyrolysis reactor through the product gas outlet, where the separator is configured to separate any particulates in a product gas produced in the pyrolysis reactor, and return the particulates to the pyrolysis reactor.

A second aspect can include the system of the first aspect, wherein the pyrolysis reactor has a tapered lower section, and wherein the bed of particulates is disposed in the tapered lower section.

A third aspect can include the system of the second aspect, wherein the pyrolysis reactor comprises an upper section have a greater cross-sectional area relative to the tapered lower section.

A fourth aspect can include the system of any one of the first to third aspects, wherein the bed of particulates in the pyrolysis reactor is configured to operate in the spouting bed flow regime.

A fifth aspect can include the system of any one of the first to fourth aspects, further comprising: a first non-mechanical valve disposed in the particulate outlet between the pyrolysis reactor and the solids heating section; and a second non-mechanical valve disposed in the particulate inlet between the solids heating section and the pyrolysis reactor.

A sixth aspect can include the system of any one of the first to fifth aspects, wherein the separator comprises a fluidized bed in a lower portion of a first stage cyclone separator, wherein the fluidized bed is configured to receive a portion of a solids product from the first stage cyclone separator, and return the solids product to the pyrolysis reactor.

A seventh aspect can include the system of any one of the first to sixth aspects, wherein the solids heating section comprises: a riser configured to receive the portion of the particulates from the pyrolysis reactor; a combustion gas inlet to accept a combustion gas; and an oxygen containing gas inlet to accept an oxygen containing gas, wherein the solids heating section is configured to contact the portion of the particulates with the combustion gas and the oxygen containing gas, combust the combustion gas to produce a combustion product gas, and heat the portion of the particulates to produce heated particulates.

An eighth aspect can include the system of the seventh aspect, wherein the combustion gas is a hydrocarbon containing gas.

A ninth aspect can include the system of the seventh or eighth aspect, wherein the solids heating section further comprises: a second separator configured to receive the portion of the heated particulates downstream of the riser and the combustion product gas, wherein the second separator is configured to separate and return the portion of the heated particulates to the pyrolysis reactor.

A tenth aspect can include the system of the ninth aspect, wherein the second separator comprises: a second fluidized bed in a lower portion of a first stage cyclone, wherein the second fluidized bed is configured to receive the portion of the heated particulate from riser; and a fluidization gas inlet in a lower portion of the first stage cyclone, wherein the fluidization gas inlet is configured to accept a gas comprising oxygen and further react the gas comprising the oxygen with the combustion product gas in the first stage cyclone.

An eleventh aspect can include the system of any one of the first to tenth aspects, wherein the separator comprises: a fluidized bed of particulates; a product gas inlet in fluid communication with the product gas outlet, wherein the product gas inlet is configured to pass the product gas through the fluidized bed; and an internal cyclone configured to retain the particulates in the separator.

A twelfth aspect can include the system of any one of the first to eleventh aspects, further comprising: one or more second stage cyclone separators, wherein the one or more second stage cyclone separators are configured to receive an outlet product gas from the first stage cyclone separator and separate any heated particulates in the outlet product gas, and return the heated particulates to the pyrolysis reactor.

A thirteenth aspect can include the system of any one of the first to twelfth aspects, wherein one or more of the pyrolysis reactor, the solids heating section, or the separator have a cold wall design.

A fourteenth aspect can include the system of any one of the first to thirteenth aspects, wherein the particulates comprise solid carbon, sand, or a catalytic material.

In a fifteenth aspect, a process for converting hydrocarbons gases to solid carbon and hydrogen products comprises: contacting a hydrocarbon in a feed stream with a bed of particulates in a pyrolysis reactor; forming solid carbon on the particulates; forming gas phase products comprising hydrogen; removing a portion of the particulates with solid carbon products from the pyrolysis reactor; heating the portion of the particulates from the pyrolysis reactor to produce heated particulates in a solid heating section; and returning the heated particulates from a solid heating section to the pyrolysis reactor.

A sixteenth aspect can include the process of the fifteenth aspect, wherein removing the portion of the particulates with solid carbon products from the pyrolysis reactor comprises passing the portion of the particulates with solid carbon products through a non-mechanical valve.

A seventeenth aspect can include the process of the sixteenth aspect, wherein the non-mechanical valve is an L-valve.

An eighteenth aspect can include the process of the sixteenth aspect, wherein the non-mechanical valve is a loop seal.

A nineteenth aspect can include the process of any one of the fifteenth to eighteenth aspects, wherein heating the portion of the particulates from the pyrolysis reactor to produce heated particulates comprises: contacting the portion of the particulates from the pyrolysis reactor with a combustion gas and an oxygen containing gas; combusting the combustion gas to produce heat and a combustion product gas; and heating the portion of the particulates with the heat to produce the heated particulates.

A twentieth aspect can include the process of the nineteenth aspect, further comprising: passing the heated particulates and the combustion product gas through a first stage cyclone separator; and separating the heated particulates from the combustion product gas, and returning the heated particulates to the pyrolysis reactor.

A twenty first aspect can include the process of the twentieth aspect, further comprising: passing a reducing gas through the heated particulates downstream of the first stage cyclone separator and upstream of the pyrolysis reactor; and reducing any oxygen containing species in the entrained combustion product gas with the returning heated particulates to the pyrolysis reactor.

A twenty second aspect can include the process of any one of the nineteenth to twenty first aspects, wherein at least one of the combustion gas or the oxygen containing gas is entrained by the portion of the particulates from the pyrolysis reactor.

A twenty third aspect can include the process of any one of the nineteenth to twenty second aspects, wherein the combustion gas comprises hydrogen.

A twenty fourth aspect can include the process of the twenty second or twenty third aspect, wherein the combustion gas is a hydrocarbon gas.

A twenty fifth aspect can include the process of any one of the nineteenth to twenty fourth aspects, wherein the oxygen containing gas comprises air or an oxygen enriched gas.

A twenty sixth aspect can include the process of any one of the fifteenth to twenty fifth aspects, further comprising: removing the gas phase products from the pyrolysis reactor; separating particulates from the gas phase products in a first stage cyclone separator wherein a first stage cyclone separator has a fluidized bed in the lower portion; and returning the separated heated particulates to the fluidized bed in the lower portion wherein the fluidized bed in the lower portion has an outlet discharging the heated particles to the pyrolysis reactor.

A twenty seventh aspect can include the process of the twenty sixth aspect, wherein separating the particulates from the gas phase products comprises: passing the gas phase products to the upper portion of the first stage cyclone separator above the fluidized bed wherein the fluid bed has a gas inlet in the lower portion for introducing a second hydrocarbon gas, cooling the particulates in the fluidized bed via pyrolysis reaction of the second hydrocarbon gas in the bed and cooling the gas phase products in the fluidized bed; and returning the particulates from the fluidized bed to the pyrolysis reactor.

A twenty eighth aspect can include the process of the twenty sixth or twenty seventh aspect, further comprising: one or more second stage cyclone separators, wherein the one or more second stage cyclone separators are configured to receive an outlet product gas from the first stage cyclone separator and separate any heated particulates in the outlet product gas and return the heated particulates to the pyrolysis reactor.

A twenty ninth aspect can include the process of the twenty seventh or twenty eighth aspect, further comprising: one or more second stage cyclone separators, wherein the one or more second stage cyclone separators are configured to receive a cooled recycled product gas at the outlet of the second stage cyclone separators outlet for quenching down the temperature of the product gas from the pyrolysis reactor.

A thirtieth aspect can include the process of any one of the fifteenth to twenty ninth aspects, further comprising: removing the gas phase products from the pyrolysis reactor; passing the gas phase products through a fluidized bed of particulates in a separator; exchanging heat between the gas phase products and the particulates in the fluidized bed; and returning the separated particulates to the fluidized bed in the lower portion wherein the fluidized bed in the lower portion has an outlet discharging the heated particles to the pyrolysis reactor.

A thirty first aspect can include the process of any one of the twenty seventh to thirtieth aspects, further comprising: reacting any unreacted hydrocarbons in the gas phase products above the fluidized bed. and cooling the gas phase products.

A thirty second aspect can include the process of any one of the fifteenth to thirty first aspects, further comprising: maintaining a temperature profile of the bed of particulates in the pyrolysis reactor, based on heating the portion of the particulates removed from a lower portion of pyrolysis reactor to produce heated particulates in the solid heating section and returning the heated particulates from the solid heating section to a upper option of the pyrolysis reactor.

A thirty third aspect can include the process of the thirty second aspect, wherein the temperature profile is further maintained based on introducing a cooled hydrocarbon gas in a lower portion of the bed of particulates in the pyrolysis reactor.

A thirty fourth aspect can include the process of any one of the fifteenth to thirty third aspects, further comprising: removing a portion of the particulates with solid carbon products from a lower portion of the bed.

A thirty fifth aspect can include the process of any one of the fifteenth to thirty fourth aspects, wherein the pyrolysis reactor has a cold wall design.

A thirty sixth aspect can include the process of any one of the fifteenth to thirty fifth aspects, wherein the particulates comprise solid carbon, sand, or a catalytic material.

In a thirty seventh aspect, a system for converting hydrocarbons gases to solid carbon and hydrogen products comprises: a pyrolysis reactor containing a bed of particulates, wherein the pyrolysis reactor comprises a feed gas inlet at a lower portion of the bed, a product gas outlet above the bed, a halogen inlet within the bed, and a solids product outlet of particulates with solid carbon in a lower portion of the pyrolysis reactor; and a separator in fluid communication with the pyrolysis reactor through the product gas outlet in the upper portion of the pyrolysis reactor, where the separator is configured to separate any particulates in a product gas produced from the pyrolysis reactor, and return the particulates to the pyrolysis reactor.

A thirty eighth aspect can include the system of the thirty seventh aspect, further comprising: a first non-mechanical valve disposed in the solid product outlet; and a second non-mechanical valve disposed in a particulate inlet disposed between the separator and the pyrolysis reactor.

A thirty ninth aspect can include the system of the thirty seventh or thirty eighth aspect, wherein the separator comprises a fluidized bed in a lower portion of a first stage cyclone separator of the separator, wherein the fluidized bed is configured to receive a portion of particulates from the pyrolysis reactor in the product gas, and return the particulates to the pyrolysis reactor.

A fortieth aspect can include the system of any one of the thirty seventh to thirty ninth aspects, wherein the pyrolysis reactor is configured to: to contact an oxidant with a hydrocarbon in the pyrolysis reactor, generate heat based on a reaction between the oxidant and the hydrocarbon, and heat the particulates in the bed of the pyrolysis reactor.

A forty first aspect can include the system of the fortieth aspect, wherein the oxidant comprises a halogen.

A forty second aspect can include the system of the forty first aspect, wherein the halogen comprises chlorine, bromine, or any combination thereof.

A forty third aspect can include the system of the fortieth aspect, wherein the oxidant comprises oxygen or sulfur.

A forty fourth aspect can include the system of any one of the thirty seventh to forty third aspects, wherein one or more of the pyrolysis reactors or the separator have a cold wall design.

A forty fifth aspect can include the system of any one of the thirty seventh to forty fourth aspects, wherein the particulates comprise solid carbon, sand, or a catalytic material.

In a forty sixth aspect, a process for converting hydrocarbons gases to solid carbon and hydrogen products comprises: introducing a feed stream comprising a hydrocarbon into a pyrolysis reactor; introducing an oxidant into the pyrolysis reactor; contacting a first portion of the hydrocarbon with a bed of particulates in the pyrolysis reactor; contacting a second portion of the hydrocarbon with the oxidant in the pyrolysis reactor; forming solid carbon on the particulates; forming gas phase products comprising hydrogen; reacting the second portion of the hydrocarbon with the oxidant to generate heat; and heating the bed of particulates to a pyrolysis reaction temperature using the heat.

A forty seventh aspect can include the process of the forty sixth aspect, wherein the heat maintains a temperature profile within the bed.

A forty eighth aspect can include the process of the forty sixth or forty seventh aspect, further comprising: removing the gas phase products from the pyrolysis reactor; separating particulates from the gas phase products in a separator; and returning the separated particulates to the pyrolysis reactor.

A forty ninth aspect can include the process of the forty eighth aspect, wherein separating the particulates from the gas phase products comprises:
passing the gas phase products to a stripper separator.

A fiftieth aspect can include the process of the forty ninth aspect, further comprising: reacting any unreacted hydrocarbons in the gas phase products in the stripper separator.

A fifty first aspect can include the process of any one of the forty sixth to fiftieth aspects, further comprising: removing a carbon product from a lower portion of the bed.

A fifty second aspect can include the process of the fifty first aspect, wherein removing the portion of the particulates from the pyrolysis reactor comprises passing the portion of the particulates through a non-mechanical valve.

A fifty third aspect can include the process of the fifty second aspect, wherein the non-mechanical valve is an L-valve.

A fifty fourth aspect can include the process of the fifty second aspect, wherein the non-mechanical valve is a loop seal.

A fifty fifth aspect can include the process of any one of the forty sixth to the fifty fourth aspect, wherein the oxidant comprises a halogen.

A fifty sixth aspect can include the process of the fifty fifth aspect, wherein the halogen comprises chlorine.

A fifty seventh aspect can include the process of the fifty fifth or fifty sixth aspect, wherein the halogen comprises bromine.

A fifty eighth aspect can include the process of any one of the forty sixth to fifty seventh aspects, wherein the oxidant comprises oxygen or sulfur.

A fifty ninth aspect can include the process of any one of the forty sixth to fifty eighth aspects, wherein the pyrolysis reactor has a cold wall design.

A sixtieth aspect can include the process of any one of the forty sixth to fifty ninth aspects, wherein the particulates comprise solid carbon, sand, or a catalytic material.

A sixty first aspect can include the process of any one of the forty sixth to sixtieth aspects, further comprising: removing the gas phase products from the pyrolysis reactor; passing the gas phase products through a fluidized bed of particulates in a separator; exchanging heat between the gas phase products and the particulates in the fluidized bed; and returning the separated particulates to the fluidized bed in the lower portion wherein the fluidized bed in the lower portion has an outlet discharging the heated particles to the pyrolysis reactor.

A sixty second aspect can include the process of the sixty first aspect, further comprising: introducing cooled particulates into the separator, wherein the cooled particulates pass to the fluidized bed of particulates in the separator; cooling the gas phase products in the fluidized bed; and heating the particulates in the fluidized bed.

A sixty third aspect can include the process of any one of the forty sixth to sixty second aspects, wherein introducing the feed stream comprising the hydrocarbon into a pyrolysis reactor comprises: counter-currently contacting the feed stream with the bed of particulates in the reactor, wherein the feed stream is at a lower temperature than the particulates in the bed of particulates; cooling the particulates in the bed of particulates based on contacting the feed stream with the bed of particulates; and heating the feed stream based on contacting the feed stream with the bed of particulates.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although claims may be formulated in this application or of any further application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicant(s) hereby give notice that new claims may be formulated to such features and/or combinations of such features during the prosecution of the present Application or of any further Application derived therefrom.

1. A system for converting hydrocarbons gases to solid carbon and hydrogen products, the system comprising:
a pyrolysis reactor containing a bed of particulates, wherein the pyrolysis reactor comprises a feed gas inlet at a lower portion of the bed, a product gas outlet above the bed, a particulate outlet above the feed gas inlet, a particulate inlet near the top of the bed, and a solids product outlet in a lower portion of the pyrolysis reactor;
a solids heating section in fluid communication with the particulate outlet and the particulate inlet, wherein the solids heating section is configured to accept a portion of the particulates from the pyrolysis reactor through the particulate outlet, heat the portion of the particulates to form heated particulates, and return the heated particulates to the pyrolysis reactor through the particulate inlet; and
a separator in fluid communication with the pyrolysis reactor through the product gas outlet, where the separator is configured to separate any particulates in a product gas produced in the pyrolysis reactor, and return the particulates to the pyrolysis reactor.

2. The system of claim 1, wherein the pyrolysis reactor has a tapered lower section and an upper section having a greater cross-sectional area relative to the tapered lower section, and wherein the bed of particulates is disposed in the tapered lower section.

3. (canceled)

4. The system of claim 1, wherein the separator comprises a fluidized bed in a lower portion of a first stage cyclone separator, wherein the fluidized bed is configured to receive a portion of a solids product from the first stage cyclone separator, and return the solids product to the pyrolysis reactor.

5. The system of claim 1, wherein the solids heating section comprises:
a riser configured to receive the portion of the particulates from the pyrolysis reactor;
a combustion gas inlet to accept a combustion gas; and
an oxygen containing gas inlet to accept an oxygen containing gas, wherein the solids heating section is configured to contact the portion of the particulates with the combustion gas and the oxygen containing gas, combust the combustion gas to produce a combustion product gas, and heat the portion of the particulates to produce heated particulates.

6. The system of claim 5, wherein the solids heating section further comprises:
a second separator configured to receive the portion of the heated particulates downstream of the riser and the combustion product gas, wherein the second separator is configured to separate and return the portion of the heated particulates to the pyrolysis reactor.

7. The system of claim 6, wherein the second separator comprises:
a second fluidized bed in a lower portion of a first stage cyclone, wherein the second fluidized bed is configured to receive the portion of the heated particulate from riser; and
a fluidization gas inlet in a lower portion of the first stage cyclone, wherein the fluidization gas inlet is configured to accept a gas comprising oxygen and further react the gas comprising the oxygen with the combustion product gas in the first stage cyclone.

8. The system of claim 1, wherein the separator comprises:
a fluidized bed of particulates;
a product gas inlet in fluid communication with the product gas outlet, wherein the product gas inlet is configured to pass the product gas through the fluidized bed; and
an internal cyclone configured to retain the particulates in the separator.

9. The system of claim 1, further comprising:
one or more second stage cyclone separators, wherein the one or more second stage cyclone separators are configured to receive an outlet product gas from the first stage cyclone separator and separate any heated particulates in the outlet product gas, and return the heated particulates to the pyrolysis reactor.

10. A process for converting hydrocarbons gases to solid carbon and hydrogen products, the process comprising:
contacting a hydrocarbon in a feed stream with a bed of particulates in a pyrolysis reactor;
forming solid carbon on the particulates;
forming gas phase products comprising hydrogen;
removing a portion of the particulates with solid carbon products from the pyrolysis reactor;
heating the portion of the particulates from the pyrolysis reactor to produce heated particulates in a solid heating section; and
returning the heated particulates from a solid heating section to the pyrolysis reactor.

11. The process of claim 10, wherein heating the portion of the particulates from the pyrolysis reactor to produce heated particulates comprises:
contacting the portion of the particulates from the pyrolysis reactor with a combustion gas and an oxygen containing gas;
combusting the combustion gas to produce heat and a combustion product gas; heating the portion of the particulates with the heat to produce the heated particulates;
passing the heated particulates and the combustion product gas through a first stage cyclone separator; and
separating the heated particulates from the combustion product gas, and returning the heated particulates to the pyrolysis reactor.

12. (canceled)

13. The process of claim 11, further comprising:
passing a reducing gas through the heated particulates downstream of the first stage cyclone separator and upstream of the pyrolysis reactor; and
reducing any oxygen containing species in the entrained combustion product gas with the returning heated particulates to the pyrolysis reactor.

14. The process of claim 10, further comprising:
removing the gas phase products from the pyrolysis reactor;
separating particulates from the gas phase products in a first stage cyclone separator wherein a first stage cyclone separator has a fluidized bed in the lower portion; and
returning the separated heated particulates to the fluidized bed in the lower portion wherein the fluidized bed in the lower portion has an outlet discharging the heated particles to the pyrolysis reactor.

15. The process of claim 14, wherein separating the particulates from the gas phase products comprises:
passing the gas phase products to the upper portion of the first stage cyclone separator above the fluidized bed wherein the fluid bed has a gas inlet in the lower portion for introducing a second hydrocarbon gas,
cooling the particulates in the fluidized bed via pyrolysis reaction of the second hydrocarbon gas in the bed and cooling the gas phase products in the fluidized bed; and
returning the particulates from the fluidized bed to the pyrolysis reactor.

16-17. (canceled)

18. The process of claim 10, further comprising:
removing the gas phase products from the pyrolysis reactor;
passing the gas phase products through a fluidized bed of particulates in a separator;
exchanging heat between the gas phase products and the particulates in the fluidized bed; and
returning the separated particulates to the fluidized bed in the lower portion wherein the fluidized bed in the lower portion has an outlet discharging the heated particles to the pyrolysis reactor.

19. The process of claim 15, further comprising:
reacting any unreacted hydrocarbons in the gas phase products above the fluidized bed. and cooling the gas phase products.

20. The process of claim 10, further comprising:
maintaining a temperature profile of the bed of particulates in the pyrolysis reactor, based on heating the portion of the particulates removed from a lower portion of pyrolysis reactor to produce heated particulates in the solid heating section and returning the heated particulates from the solid heating section to an upper portion of the pyrolysis reactor.

21-26. (canceled)

27. A process for converting hydrocarbons gases to solid carbon and hydrogen products, the process comprising:
introducing a feed stream comprising a hydrocarbon into a pyrolysis reactor;
introducing an oxidant into the pyrolysis reactor;
contacting a first portion of the hydrocarbon with a bed of particulates in the pyrolysis reactor;
contacting a second portion of the hydrocarbon with the oxidant in the pyrolysis reactor;
forming solid carbon on the particulates;
forming gas phase products comprising hydrogen;
reacting the second portion of the hydrocarbon with the oxidant to generate heat; and
heating the bed of particulates to a pyrolysis reaction temperature using the heat.

28. The process of claim 27, further comprising:
removing the gas phase products from the pyrolysis reactor;
separating particulates from the gas phase products in a separator; and
returning the separated particulates to the pyrolysis reactor.

29. The process of claim 27, further comprising:
removing a carbon product from a lower portion of the bed.

30. The process of claim 29, wherein removing the portion of the particulates from the pyrolysis reactor comprises passing the portion of the particulates through a non-mechanical valve.

31. The process of claim 27, wherein the oxidant comprises a halogen, oxygen, or sulfur.

32. The process of claim 27, further comprising:
removing the gas phase products from the pyrolysis reactor;
passing the gas phase products through a fluidized bed of particulates in a separator;
exchanging heat between the gas phase products and the particulates in the fluidized bed; and
returning the separated particulates to the fluidized bed in the lower portion wherein the fluidized bed in the lower portion has an outlet discharging the heated particles to the pyrolysis reactor.

33. The process of claim 32, further comprising:
introducing cooled particulates into the separator, wherein the cooled particulates pass to the fluidized bed of particulates in the separator;
cooling the gas phase products in the fluidized bed; and
heating the particulates in the fluidized bed.

34. The process of claim 27, wherein introducing the feed stream comprising the hydrocarbon into a pyrolysis reactor comprises:
counter-currently contacting the feed stream with the bed of particulates in the reactor, wherein the feed stream is at a lower temperature than the particulates in the bed of particulates;
cooling the particulates in the bed of particulates based on contacting the feed stream with the bed of particulates; and
heating the feed stream based on contacting the feed stream with the bed of particulates.
